(19) United States
(12) Patent Application Publication
(10) Pub. No.: US 2022/0207948 A1
(43) Pub. Date: Jun. 30, 2022

(54) Banknote Conveying Module and Banknote Adding Machine Thereof

(71) Applicant: WEIRONG TECHNOLOGY CORPORATION, Wenzhou, Province (CN)

(72) Inventors: Wei WEI, Wenzhou (CN); Zhen FANG, Wenzhou (CN); Debei CHEN, Wenzhou (CN); Wei GUAN, Wenzhou (CN); Yaozhun CAI, Wenzhou (CN); Batao NI, Wenzhou (CN); Ronghai LI, Wenzhou (CN); Xiaolan WEI, Wenzhou (CN); Maoxing WANG, Wenzhou (CN)

(21) Appl. No.: 17/602,088

(22) PCT Filed: Sep. 30, 2020
(86) PCT No.: PCT/CN2020/117000

§ 371 Date: Oct. 7, 2021

(30) Foreign Application Priority Data
Oct. 10, 2019 (CN) 201910959883.1

(51) Int. Cl. G07D 11/12; G07D 11/00

(52) U.S. Cl. CPC G07D 11/12; G07D 11/009

(57) ABSTRACT

A banknote conveying module and a banknote adding machine thereof. The banknote conveying module comprises a lower banknote conveying plate (C182) and an upper banknote conveying plate (C181), a banknote conveying gap (C101) being formed between the upper banknote conveying plate (C181) and the lower banknote conveying plate (C182); an upper banknote conveying belt (C540) is mounted at the side in the banknote conveying gap (C101) close to the upper banknote conveying plate (C181), a lower banknote conveying belt (C550) is mounted at the side in the banknote conveying gap (C101) close to the lower banknote conveying plate (C182), and banknotes are clamped between the lower banknote conveying belt (C550) and the upper banknote conveying belt (C540) so as to be conveyed; each banknote box (500) corresponds to a group of a lower banknote conveying belt (C550), an upper banknote conveying belt (C540) and a reversing assembly, the reversing assembly comprises a reversing mounting plate (C710), the reversing mounting plate (C710) is fixed at the bottom of the lower banknote conveying plate (C182), and multiple reversing blocks (C740) are mounted and fixed above the reversing mounting plate (C710), the reversing blocks (C740) and two lower banknote conveying side plates (C183) are circumferentially and rotatably assembled by means of reversing shafts (C720), one end of each of the reversing shafts (C720) penetrates through one of the lower banknote conveying side plates (C183) and then is tangentially connected to a telescopic shaft of a reversing electromagnet (C420); and each of the reversing blocks (C740) is provided with a banknote feeding cambered surface (C741), a banknote passing planar surface (C742) and an stopping end (C743), and a banknote feeding guide plate (C730) is mounted at the lower banknote conveying plate (C182) at a corresponding position.

### BACKGROUND OF THE PRESENT INVENTION

### Field of Invention

The present invention relates to financial equipment, and more particularly, to a banknote conveying module and banknote adding machine thereof.

### Description of Related Arts

The financial institution typically needs to store the bills in an independent cash box during the banknote dispensing process, and then, money is deposited in the cash box, thereby facilitating the transportation of the banknotes. However, the depositing of banknote into the cash box mostly through a large and independent banknote distribution flow line, and such arrangement is mainly utilized for a large amount of banknote distribution. However, for some small financial institutions, such flow line is too large, which can increase the purchase and management costs of the financial institution.

Therefore, a banknote conveying module and banknote adding machine thereof is designed, which banknote adding machine is small in size and capable of automatically adding banknotes into the cash box.

### SUMMARY OF THE PRESENT INVENTION

In view of the conventional drawbacks of the prior art mentioned above, the present invention is provided to solve the technical problems that includes a banknote conveying module and banknote adding machine thereof, which banknote feeding module is capable of selecting banknote to deliver into a banknote box.

In order to achieve the above and other objectives, the present invention provides a banknote conveying module, which comprises: a lower banknote conveying plate and an upper banknote conveying plate, and has a banknote conveying gap formed between the upper banknote conveying plate and the lower banknote conveying plate, wherein an upper banknote conveying belt is mounted by a side of the upper banknote conveying plate in the banknote conveying gap and a lower banknote conveying belt is mounted by a side of the lower banknote conveying plate in the banknote conveying gap, wherein the lower banknote conveying belt and the upper banknote conveying belt jointly clamp banknotes so as to convey the banknotes;

each of the banknote boxes corresponding to a set of lower banknote conveying belt, upper banknote conveying belt, and reversing assembly, wherein the reversing assembly comprises a reversing mounting plate, the reversing mounting plate being affixed on the bottom of the lower banknote conveying plate, a plurality of reversing blocks being mounted and affixed above the reversing mounting plate, the reversing block being circumferentially and rotatably assembled with the two lower banknote conveying side plates through the reversing shaft, and an end of the reversing shaft penetrates out of one of the lower banknote conveying side plates to be tangentially connected to a telescopic shaft of a reversing electromagnet, each of the reversing blocks having a banknote feeding cambered surface, a banknote passing planar surface, and a stopping end arranged thereon, the lower banknote conveying plate comprising a banknote feeding guide plate mounted at the corresponding position, the stopping end being arranged at the end of the banknote feeding cambered surface that is away from the banknote feeding cambered surface.

Preferably, in an initial state, the banknote passing planar surface does not enter the banknote conveying gap, and the banknote feeding cambered surface is fitted with the banknote feeding guide plate.

Preferably, the upper banknote conveying plate and the lower banknote conveying plate have two banknote guiding plates respectively arranged at an banknote conveying direction end thereof and a banknote receiving plate arranged at the other end thereof.

Preferably, the upper banknote conveying belt is wound around an upper first banknote conveying belt pulley, an upper second banknote conveying belt pulley, an upper third banknote conveying belt pulley, and an upper fourth banknote conveying belt pulley, so as to form a belt transmission mechanism, wherein the upper first banknote conveying belt pulley, the upper second banknote conveying belt pulley, the upper third banknote conveying belt pulley, and the upper fourth banknote conveying belt pulley are respectively mounted on an upper first banknote conveying shaft, an upper second banknote conveying shaft, an upper third banknote conveying shaft, and an upper fourth banknote conveying shaft, wherein the upper first banknote conveying shaft, the upper second banknote conveying shaft, the upper third banknote conveying shaft, and the upper fourth banknote conveying shaft are rotatably assembled on the upper banknote conveying side plates respectively and affixed on the two sides of the upper banknote conveying plate respectively.

Preferably, the upper banknote conveying plate is further installed with a belt pinch roller, wherein the belt pinch roller is adapted to press and hold the upper banknote conveying belt.

Preferably, the two upper banknote conveying side plates are respectively arranged on inner sides of the two lower banknote conveying side plate, and the two lower banknote conveying side plates are circularly and rotatably assembled with a lower first banknote conveying shaft at a position corresponding to the upper first banknote conveying shaft, an end of the lower first banknote conveying shaft penetrating through one of the lower banknote conveying side plate to be assembled and affixed with an encoder disk, a second first belt pulley and a first second belt pulley, the first second belt pulley being connected with a first first belt pulley through a first belt so as to form a belt transmission mechanism, the first first belt pulley being mounted on an output shaft of a banknote conveying motor, the banknote conveying motor being affixed inside a housing;

the second first belt pulley being connected with a second second belt pulley through a second belt to form a belt transmission mechanism, the second second belt pulley bemounted on the lower third banknote conveying shaft, the lower third banknote conveying shaft comprising a third first belt pulley mounted thereon, the third first belt pulley being connected with a third second belt pulley through a third belt to form a belt transmission mechanism, the third second belt pulley being mounted on a lower fifth banknote conveying shaft, the lower fifth banknote conveying shaft being circumferentially and rotatably assembled at two first shaft holes provided in the two lower banknote conveying side plates respectively, the lower fifth banknote conveying shaft comprising a connection belt pulley mounted thereon.

Preferably, a lower first banknote conveying belt pulley is mounted on the lower first banknote conveying shaft at a position corresponding to the upper first banknote conveying belt pulley, wherein the lower first banknote conveying belt pulley is connected with a lower second banknote conveying belt pulley through the lower banknote conveying belt to form a belt transmission mechanism, the lower third banknote conveying shaft comprising another lower second banknote conveying belt pulley mounted thereon, which is connected with another the lower first banknote conveying belt pulley through another the lower banknote conveying belt to form a belt transmission mechanism, the lower first banknote conveying belt pulley being mounted on a lower fourth banknote conveying shaft, the lower fourth banknote conveying shaft being circumferentially and rotatably assembled on the two lower banknote conveying side plates.

Preferably, a lower connecting spacing board is mounted between the two lower banknote conveying side plates and a position the lower banknote conveying plate and the pinch guiding wheel are assembled, wherein the lower connecting spacing board is adapted to connect the two lower banknote conveying side plates, and the pinch guiding wheel penetrates through the lower connecting spacing board to pinch with the top of the banknote box for the assembling.

The present invention also provides a banknote adding machine, which utilizes the above banknote conveying modules.

Preferably, the banknote adding machine further comprises a housing, which has an opening formed on a side thereof, and an integrated box mounted therein, wherein a bottom of the housing is a bottom wall, wherein the integrated box is slidably assembled with an inner wall of the housing through a sliding rail, wherein the opening or closing of an opening of the housing is operated through a box door mechanism thereat, wherein a banknote box is mounted in the integrated box, and a positioning driving mechanism is mounted on a bottom of the banknote box;

the banknote box comprising a banknote receiving wheel mounted therein on a banknote receiving shaft, the banknote receiving shaft being rotatably assembled on an inner wall of the banknote box, the banknote receiving wheel and the driving wheel being engaged for transmission, the banknote receiving wheel being positioned under a gap between the banknote feeding cambered surface and the banknote feeding guide plate, a driving wheel being mounted on a driving shaft which comprises a second belt pulley mounted thereon, the driving shaft being circumferentially and rotatably mounted on a support board, the support board being affixed on the outer wall of the banknote box, the second belt pulley being connected with a first belt pulley through a driving belt to form a belt transmission mechanism, the first belt pulley being affixed on the output shaft of a banknote receiving motor, the banknote receiving motor being affixed on the support board;

the box door mechanism comprising a box door which has a box door through groove formed therein, a box door opening plate being installed in the box door through groove, the box door opening plate being assembled and affixed with box door hinge, the box door respectively having a box door hinge retaining plate and box door channel steel, the box door hinge retaining plate sealing a part of the box door through groove close to the inside of the housing, a box door lock shaft being rotatably assembled on the box door hinge retaining plate;

two ends of the box door lock shaft being assembled and affixed on a pair of box door lock plates respectively, the box door lock plate having a box door lock groove and a box door spring hole arranged thereon, the box door lock groove and a box door lock pin being engaged with each other, an end of the box door lock pin being affixed on an inner wall of the housing, the box door spring hole and an end of a box door extension spring being hookedly assembled, while another end of the box door extension spring and a box door extension spring hole being hookedly assembled, the box door extension spring hole being provided in a box door spring plate, the box door spring plate being affixed on the housing;

a top of the housing being closed through the lower banknote conveying plate, three side walls of the housing adjacent to the integrated box and a top of the lower banknote conveying plate each having a pinch guiding wheel circumferentially and rotatably mounted thereon, the pinch guiding wheels on the inner walls of the housing pinching the three sides of the integrated box, while the pinch guiding wheel on the lower banknote conveying plate pinches the top of the banknote box.

The present invention provides the following benefits and advantages:

1. The present invention has advantages of simple structure, small size, and functions of allowing one-by-one banknote adding to the two cash boxes, thereby achieving quick cash dispensing. In addition, the integrated box can be separately pulled out of the housing, thereby facilitating removal and replacement of the cash box.

2. The banknote conveying unit of the present invention is capable of achieving the transportation and direction change of the banknotes, so that each of the banknote boxes can be refilled independently.

3. The lid lock unit of the present invention is capable of achieving effective locking of the banknote conveying unit and very convenient unlocking, which is very beneficial to later check and maintenance.

4. The box door mechanism of the present invention can realize opening and closing of the housing, thereby facilitating the pull-out and loading of the case. The box door mechanism is simple in structure and convenient to use.

### BRIEF DESCRIPTION OF THE DRAWINGS

FIGS. 1-5 are structural perspective views of a preferred embodiment of the present invention.

FIGS. 6-9 are perspective views of a box door mechanism according to the above preferred embodiment of the present invention.

FIGS. 10-16 are structrual perspective views according to the above preferred embodiment of the present invention.

FIG. 17 is a perspective view of a positioning drive unit according to the above preferred embodiment of the present invention.

FIGS. 18-20 are perspective views of a banknote conveying unit according to the above preferred embodiment of the present invention.

FIGS. 21-25 are perspective views of a lid lock unit according to the above preferred embodiment of the present invention.

FIGS. 26-23 are perspective views of a banknote conveying unit according to the above preferred embodiment of the present invention.

FIGS. 32-34 are structural perspective views according to the above preferred embodiment of the present invention, wherein FIG. 33 is an enlarged view of the F 1 position of FIG. 32.

### DETAILED DESCRIPTION OF THE PREFERRED EMBODIMENT

The technical solutions of the embodiments of the present invention will be described more fully hereinafter with reference to the accompanying drawings of embodiments of the invention.

In the description of the invention, it is to be understood that, the term “upper,” “lower,” “ front,” “rear,” “left,” “right,” “top,” “bottom,” “inner,” “outer,” etc., are based on the orientation or positional relationship shown in the figures, but are merely intended to facilitate the description of the present invention and the simplified description, rather than to indicate or imply that the indicated device or element must have a particular orientation, constructed and operative in a particular orientation, and therefore not to be construed as a limitation of the present invention.

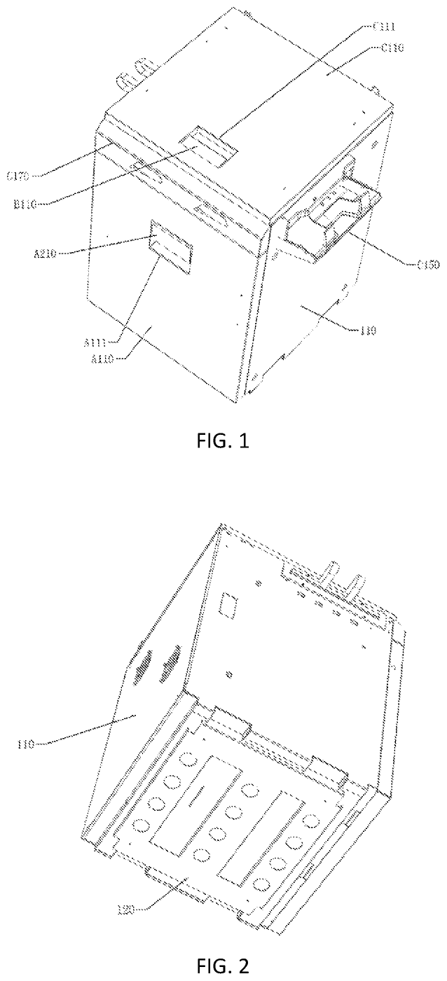

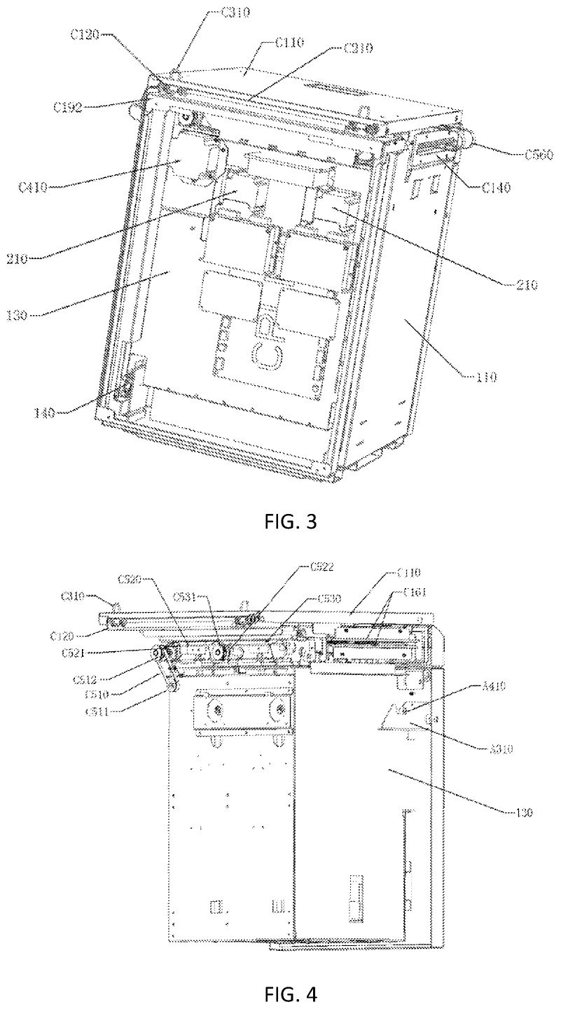

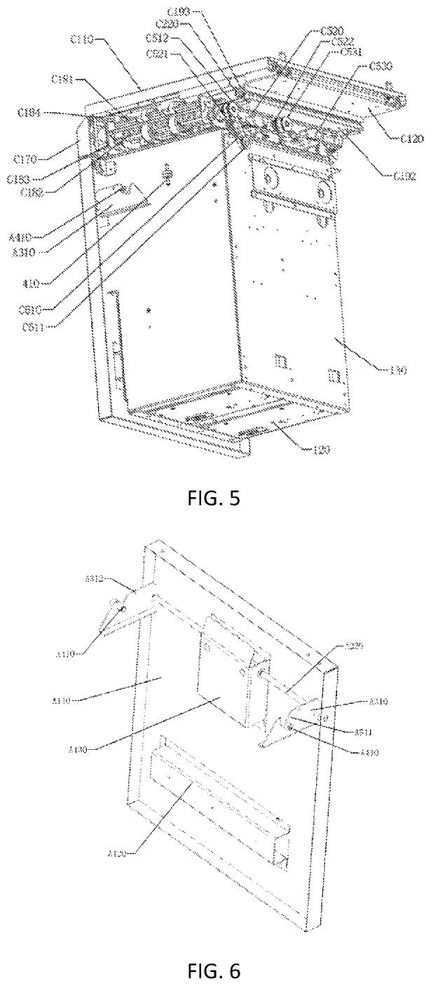

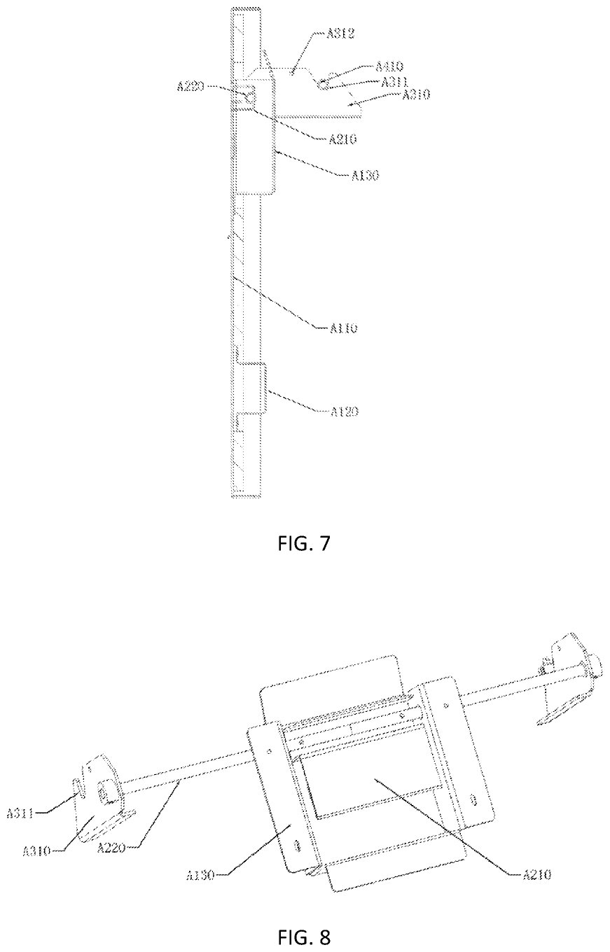

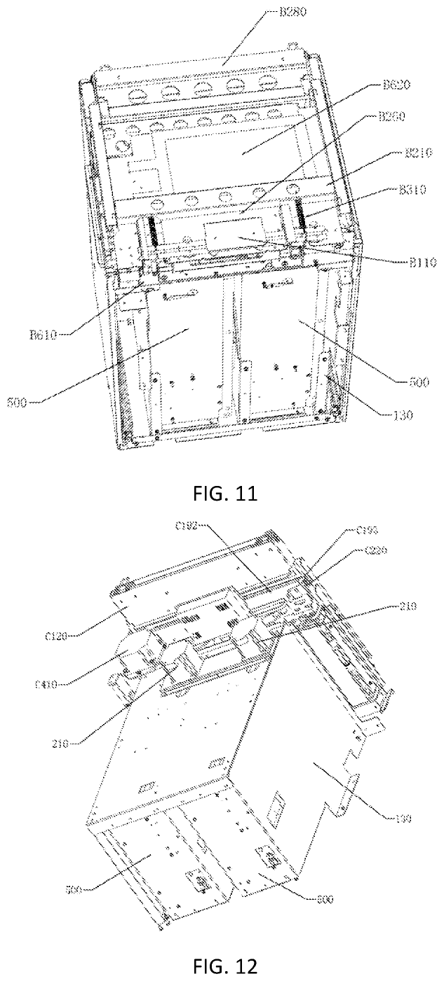

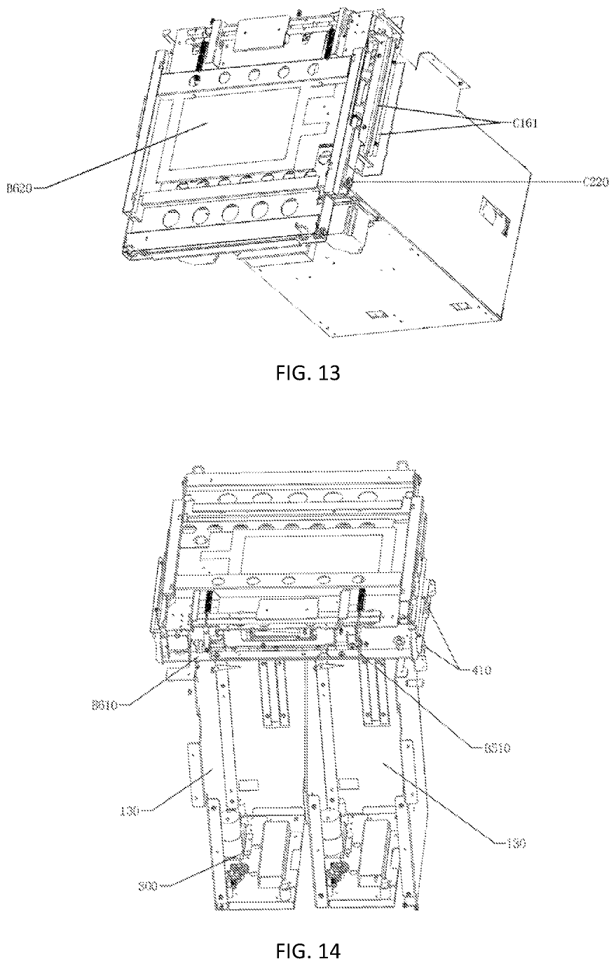

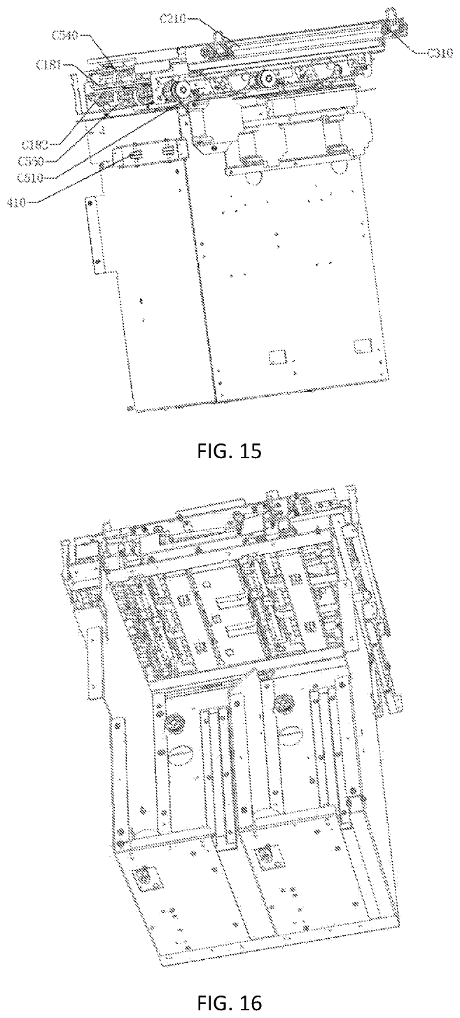

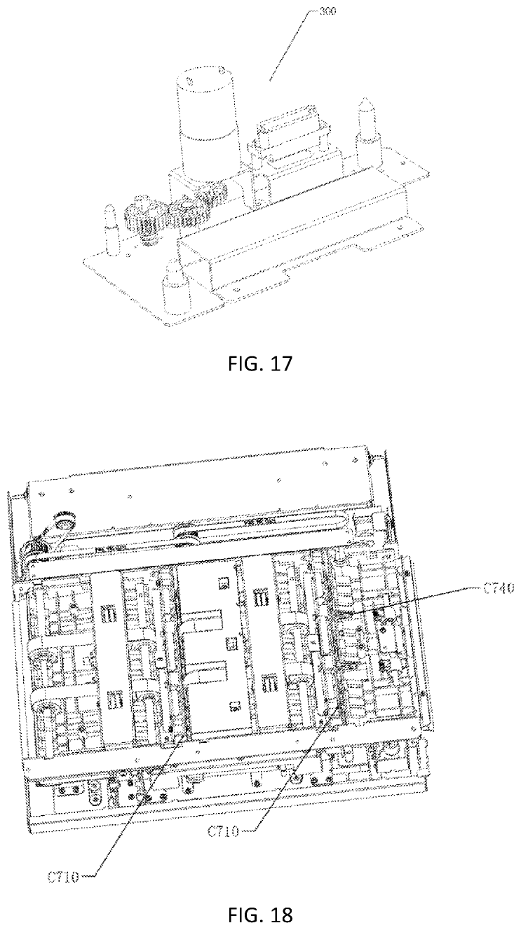

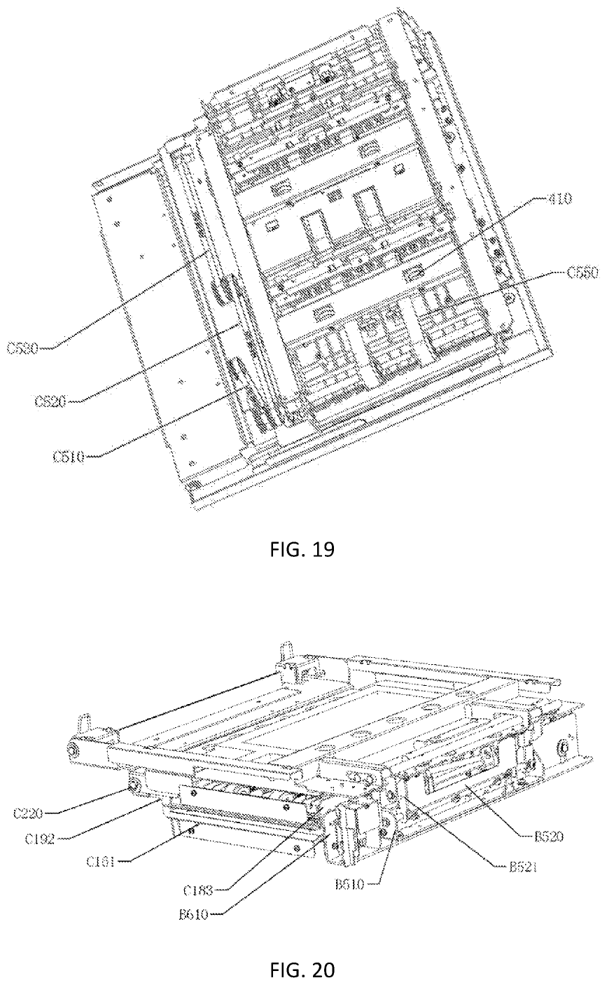

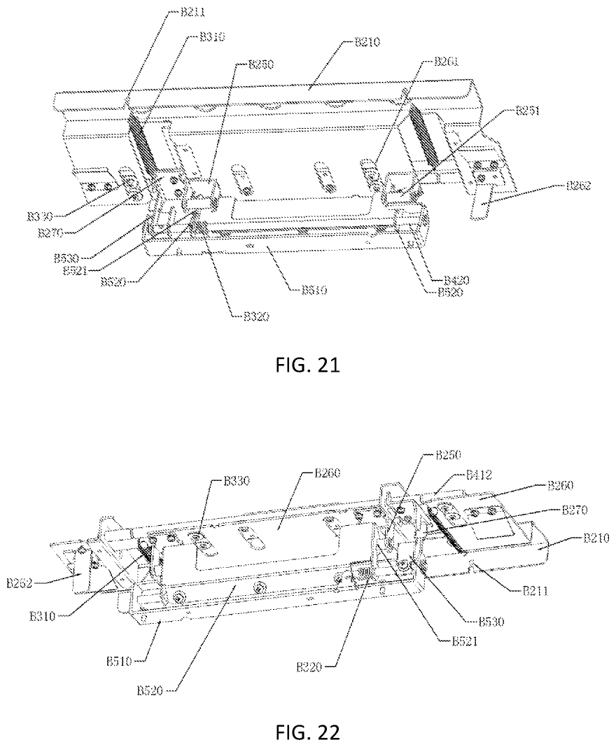

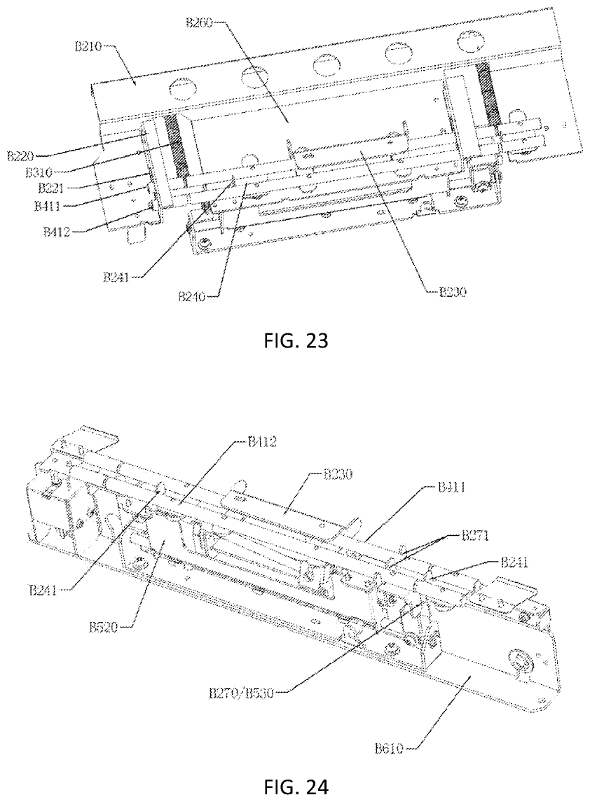

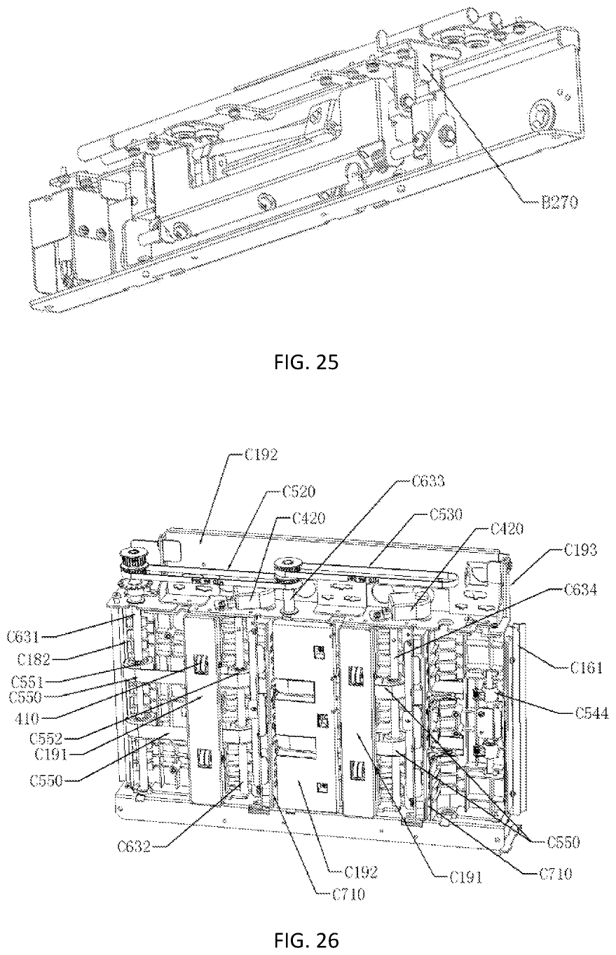

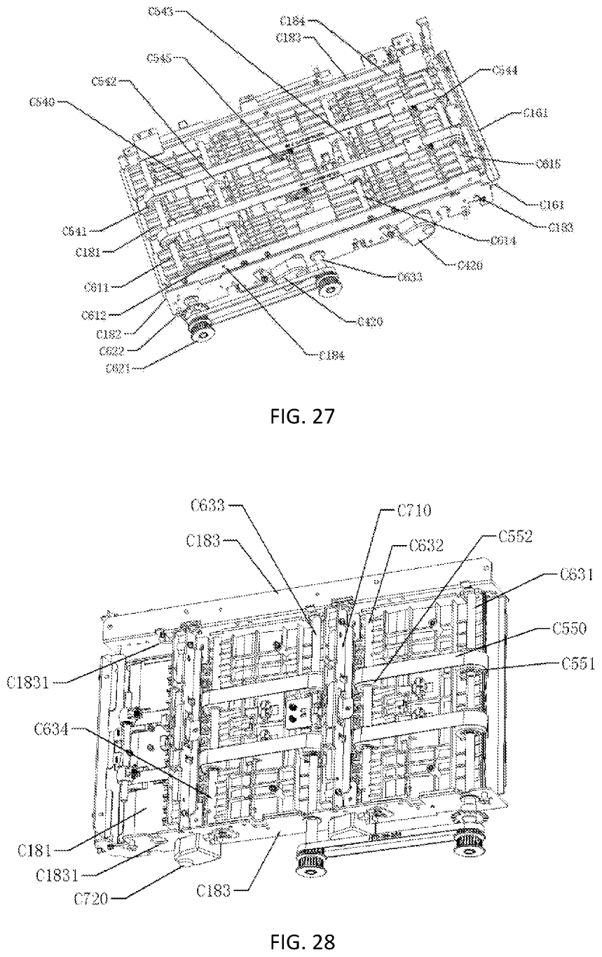

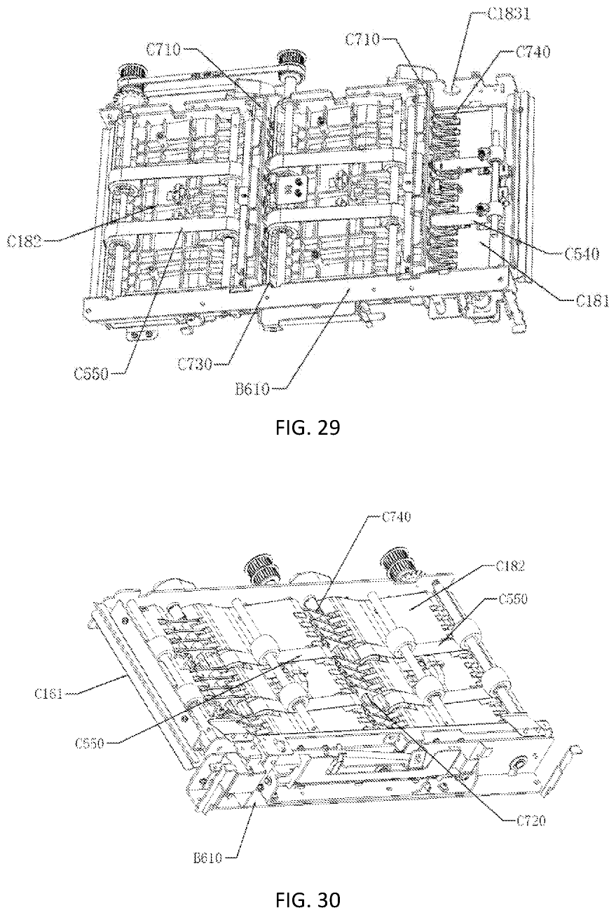

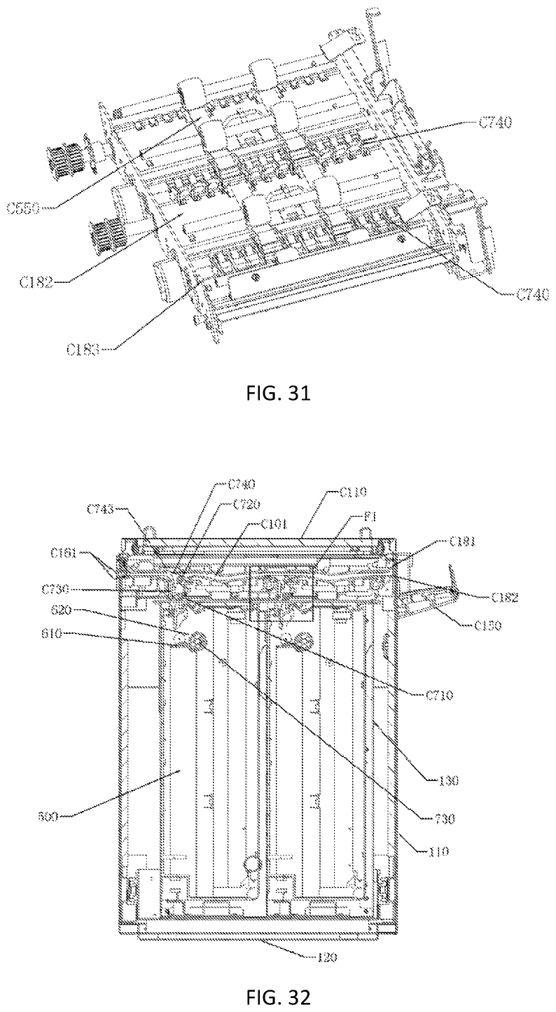

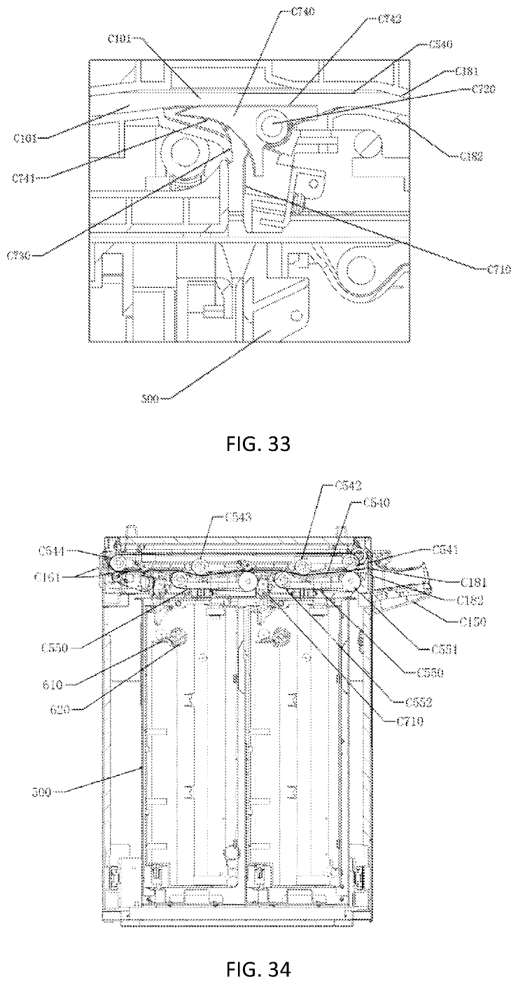

Referring to FIGS. 1-34, a banknote adding machine comprises a housing 110, wherein the housing 110 comprises an integrated box 130 mounted therein and has a side opening and a bottom wall 120 at a bottom of the housing 110. The integrated box 130 is assembled on an inner wall of the housing 110 through a sliding rail 140, so as to allow the integrated box 130 to be pulled out from the housing 110 through the sliding rail. The opening of the housing 110 is closed by means of a box door mechanism. The box door mechanism comprises a box door A110, which has a box door through groove A111 formed therein, and a box door opening plate A210 installed in the box door through groove A111, wherein the box door opening plate A210 is assembled and affixed a box door hinge A220, wherein the box door A110 has a box door hinge retaining plate A130 and a box door channel steel member A120, wherein the box door hinge retaining plate

A130 seals a part of the box door through groove A111 adjacent to an inside of the housing 110, wherein a box door lock shaft A220 is rotatably assembled on the box door hinge retaining plate A130.

Two ends of the box door lock shaft A220 are respectively assembled and affixed on a pair of box door lock plates A310, wherein each of the box door lock plates A310 has a box door lock groove A311 and a box door spring hole A312 arranged thereon, wherein the box door lock groove A311 and a box door lock pin A410 are engaged with each other, wherein an end of the box door lock pin A410 is affixed on an inner wall of the housing 110. The box door spring hole A312 and an end of a box door extension spring A420 are hookedly assembled, while the other end of the box door extension spring A420 and a box door extension spring hole A431 is hookedly assembled. The box door extension spring hole A431 is provided in a box door spring plate A430, wherein the box door spring plate A430 is affixed on the housing 110. For operation, a pulling force of the box door extension spring 420 is applied to turn the box door lock plate A310 towards the box door lock pin A410 so as to maintain the assembling engagement of the box door lock groove A311 with the box door lock pin.

When the box door A110 is needed to be opened, the hand merely requires to extend into the box door lock groove A111 and pull out the box door opening plate A210 with fingers so as to drive the box door lock shaft A220 to pivotally rotate, so that the box door lock shaft A220 drive the box door lock plate A310 to rotate synchronously. Therefore, the box door lock groove A311 can overcome the elastic tension of the box door extension spring A420 to rotate towards a direction of the box door lock pin A410 until the box door lock groove A311 decouples with the box door lock pin A410. At this moment, the box door A110 is allowed to be turned upward and opened, so as to open the opening of the housing 110, such that the integrated box 130 can be pulled out for picking, placing, and replacing one or more banknote boxes 500.

One or more banknote boxes 500 are mounted in the integrated box 130. A positioning driving mechanism 300 is arranged at a bottom of each of the banknote boxes 500. The positioning driving mechanism 300 and the banknote box 500 according to the preferred embodiment may be embodied and referred to the positioning driving mechanism and the banknote box disclosed in another China patent application, entitled “A Manual Banknote Adding Box”, filed on the same date of the present invention.

A top of the housing 110 is closed by a lower banknote conveying plate C182, wherein three side walls (besides the one with the box door A110 mounted thereon) of the housing 110, adjacent to the integrated box 130, and the lower banknote conveying plate C182 each has a pinch guiding wheel 410 rotatably mounted thereon. The pinch guiding wheels 410 rotatably mounted on the three inner walls of the housing 110 are arranged to pressing and pinching against three side surfaces of the integrated box 130 respectively, while the pinch guiding wheel 410 rotatably mounted on the lower banknote conveying plate C182 presses and pinches a top surface of the banknote box 500, so as to tightly hold the one or more banknote boxes 500 and the integrated box 130 in position as well as to reduce the friction among the banknote box(es), the integrated box 130 and the pinch guiding wheels 410.

The banknote conveying module which includes the lower banknote conveying plate C182 further comprises an upper banknote conveying plate C181 and a banknote conveying gap C101 formed and defined between the upper banknote conveying plate C181 and the lower banknote conveying plate C182. Also, one end of each of the upper banknote conveying plate C181 and the lower banknote conveying plate C182, where the banknotes delivering at this direction, has two banknote guiding plates C161 arranged thereat while another end of each of the upper banknote conveying plate C181 and the lower banknote conveying plate C182 has a banknote receiving plate C150 arranged thereat. During operation, the banknotes enter a banknote conveying gap C101 defined between the two banknote guiding plates C161 and then deliver into the corresponding banknote box 500 through a reversing assembly or sent to the banknote receiving plate C150 through the banknote conveying gap C101 for temporary storage when the banknote boxes 500 are full.

An upper banknote conveying belt C540 is mounted at a side adjacent to the upper banknote conveying plate C181 in the banknote conveying gap C101. The upper banknote conveying belt C540 is wound around an upper first banknote conveying belt pulley C541, an upper second banknote conveying belt pulley C542, an upper third banknote conveying belt pulley C543, and an upper fourth banknote conveying belt pulley C544 so as to form a belt transmission mechanism. The upper first banknote conveying belt pulley C541, the upper second banknote conveying belt pulley C542, the upper third banknote conveying belt pulley C543, and the upper fourth banknote conveying belt pulley C544 are respectively mounted on an upper first banknote conveying shaft C611, an upper second banknote conveying shaft C612, an upper third banknote conveying shaft C613, and an upper fourth banknote conveying shaft C614, wherein the upper first banknote conveying shaft C611, the upper second banknote conveying shaft C612, the upper third banknote conveying shaft C613, and the upper fourth banknote conveying shaft C614 are respectively rotatably assembled on the upper banknote conveying side plates C184 which are affixed on two sides of the upper banknote conveying plate C181 respectively. Preferably, the upper banknote conveying plate C181 further has a belt pinch roller C545 installed thereon, wherein the belt pinch roller C545 is configured to press and hold the upper banknote conveying belt C540 in position.

The two upper banknote conveying side plates C184 are respectively arranged on inner sides of the two lower banknote conveying side plate C183, and that the two lower banknote conveying side plates C183 are rotatably assembled with a lower first banknote conveying shaft C631 in pivotally manner at the position corresponding to the upper first banknote conveying shaft C611, wherein one end of the lower first banknote conveying shaft C631 penetrates through one of the lower banknote conveying side plates C183 and then fixedly assembles with an encoder disk C621, a second-first belt pulley C521 and a first-second belt pulley C512. The first-second belt pulley C512 is connected with a first-first belt pulley C511 through a first belt C510 to as to form a belt transmission mechanism, wherein the first-first belt pulley C511 is mounted on an output shaft of a banknote conveying motor C410 which is affixed inside of the housing 110. The encoder disk C621 has a plurality of through slots. An eddy current sensor C622 is mounted in a vicinity of the encoder disk C621 in such a manner that a sensing terminal thereof faces an end face of the encoder disk C621. When in use, the encoder disk C621 is rotated so the through slots are alternately switching to face the sensing terminal of the eddy current sensor C622 in a continuous manner so as to have the eddy current sensor C622 sending electrical signals to detect a rotational speed of the encoder disk C621.

The second-first belt pulley C521 is connected with a second-second belt pulley C522 through a second belt C520 to form a belt transmission mechanism, wherein the second-second belt pulley C522 is mounted on the lower third banknote conveying shaft C633 which comprises a third-first belt pulley C531 mounted thereon, wherein the third-first belt pulley C531 is connected with a third-second belt pulley (not shown in the figures) through a third belt C530 to form a belt transmission mechanism. The third-second belt pulley is mounted on a lower fifth banknote conveying shaft (not shown in the figures), wherein the lower fifth banknote conveying shaft is rotatably assembled at a first shaft hole C1831 provided on the two lower banknote conveying side plates C183, wherein the lower fifth banknote conveying shaft has a connection belt pulley mounted thereon. According to the present embodiment, the connection belt pulley is connected with the belt pulley of an external banknote dispensing machine through a connection belt C560 to form a belt transmission mechanism, so as to input the banknotes output by the banknote dispensing machine into the banknote conveying gap C101.

A lower first banknote conveying belt pulley C541 is mounted on the lower first banknote conveying shaft C631 at a position corresponding to the upper first banknote conveying belt pulley C552, wherein the lower first banknote conveying belt pulley C551 is connected with a lower second banknote conveying belt pulley C552 through a lower banknote conveying belt C550 to form a belt transmission mechanism. Another lower second banknote conveying belt pulley C522 which is mounted on the lower third banknote conveying shaft C633 is connected with another the lower first banknote conveying belt pulley C551 through another lower banknote conveying belt C550 to form another belt transmission mechanism, wherein the another lower first banknote conveying belt pulley C551 is mounted on a lower fourth banknote conveying shaft C634, which is rotatably assembled on the two lower banknote conveying side plates C183. A top of the lower banknote conveying belt C550 is positioned at a side of the banknote conveying gap C101 adjacent to the lower banknote conveying plate C182. The lower banknote conveying belt C550 and the upper banknote conveying belt C540 are configured to tightly press against the banknotes for delivering the banknotes.

Preferably, a lower connecting spacing board C191 is mounted between the two lower banknote conveying side plates C183 where the lower banknote conveying plate C182 and the pinch guiding wheel 410 are assembled, wherein the lower connecting spacing board C191 is arranged for connecting the two lower banknote conveying side plates C183, wherein a bottom of the pinch guiding wheel 410 penetrates through the lower connecting spacing board C191 to tightly press against a top portion of the banknote box 500 for assembling.

According to the present embodiment, each of the banknote boxes is corresponding to a set of the lower banknote conveying belt C550 and the reversing assembly. The reversing assembly comprises a reversing mounting plate C710 which is affixed on a bottom portion of the lower banknote conveying plate C182, wherein a plurality of reversing blocks C740 is mounted and affixed above the reversing mounting plate C710, wherein each of the reversing blocks is rotatably assembled with the two lower banknote conveying side plates C183 through a reversing shaft C720, wherein an end of the reversing shaft C720 penetrates out of one of the lower banknote conveying side plates C183 and then tangentially connects to a telescopic shaft of a reversing electromagnet C420. In other words, the telescopic shaft of the reversing electromagnet C420 is tangentially connected to an outer wall, at a circumferential direction, of the reversing shafts C720. Such that, when the telescopic shaft of the reversing electromagnet C420 peripherally moves, the reversing shafts C720 can therefore be driven to rotate along a circumference direction. As a result, the reversing blocks C740 can be driven to rotate synchronously.

The reversing blocks C740 has a banknote feeding cambered surface C741, a banknote passing planar surface C742 and a stopping end C743 arranged thereon. The lower banknote conveying plate C182 comprises a banknote feeding guide plate C730 at a corresponding position. The stopping end C743 is arranged at a distal end of the banknote feeding cambered surface C741 that is away from the banknote box 500. In an initial state, the banknote passing planar surface C742 does not enter the banknote conveying gap C101, and the banknote feeding cambered surface C741 is fitted with the banknote feeding guide plate C730. At this time, the banknote is directly moved on top of the banknote passing planar surface C742 but not entering the gap between the banknote feeding cambered surface C741 and the banknote feeding guide plate C730, that is the banknote box 500 corresponding to the reversing assembly does not have banknote input. Hence, when the banknote is required to be delivered into the banknote box corresponding to the reversing assembly, the telescopic shaft of the reversing electromagnet C420 drives the reversing shaft C720 to rotate, so as to tilt the ends of the reversing blocks C740, each of which has a stopping end C743 arranged thereat, in order to block the banknote conveying gap C101. At this moment, the gap between the banknote feeding cambered surface C741 and the banknote feeding guide plate C730 is opened and the banknotes are allowed to enter the gap to deliver into the corresponding banknote box 500, so as to accomplish the task of selectively adding banknotes into the selected banknote box 500. After the banknote adding is completed, the telescopic shaft of the reversing electromagnet driver is reversed to restore the reversing blocks C740, and then the reversing blocks C740 corresponding to the another banknote box 500 are tilted for the banknotes entering the next selected banknote box 500.

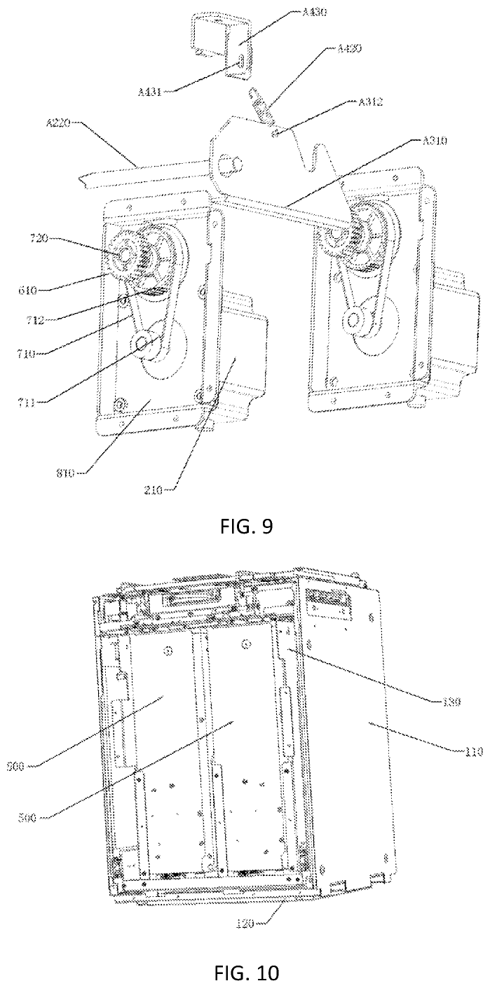

Referring to FIG. 9 and FIG. 30, each of the banknote boxes 500 comprises a banknote receiving wheel 620 installed thereon, wherein the banknote receiving wheel 620 is mounted on a banknote receiving shaft 730, wherein the banknote receiving shaft 730 is rotatably assembled on an inner wall of the banknote box 500. The banknote receiving wheel 620 and the driving wheel 610 are engaged for transmission, wherein the banknote receiving wheel 620 is positioned under the gap between the banknote feeding cambered surface C741 and the banknote feeding guide plate C730, and the driving wheel 610 is mounted on a driving shaft 720, wherein the driving shaft 720 comprises a second belt pulley 712 mounted thereon and is rotatably mounted on a support board 810, which is affixed on an outer wall of the banknote box 500. The second belt pulley 712 is connected with a first belt pulley 711 through a driving belt 710 to form a belt transmission mechanism, wherein the first belt pulley 711 is mounted on an output shaft of a banknote receiving motor 210 affixed on the support board 810. When adding banknotes into the banknote box 500, the banknote receiving motor 210 is electrified and activated to drive the banknote receiving wheel 620 to rotate. A plurality of banknote receiving grooves (gear grooves) is provided along a circumference direction of the banknote receiving wheel 620, such that when a banknote is dropped to a position of the banknote receiving wheel 620, one end of the banknote is loaded into one of the banknote receiving grooves and then the banknote receiving wheel 620 drives the banknote to rotate to a horizontal direction and to slide out of the banknote receiving groove due to gravity force. At this moment, the banknote is flatly placed in a horizontal state (horizontal end face) that facilitates the piling up of the banknotes. According to the present embodiment, when the banknote falls through the gap between the banknote feeding cambered surface C741 and the banknote feeding guide plate C730 to the banknote receiving wheel 620, a length direction of the banknote is inclined in a top-down manner from the vicinity of the banknote feeding guide plate C730 to the banknote receiving wheel 620 and rotated by the banknote receiving wheel 620 to the horizontal direction to drop down, so as to avoid the banknotes from folding, bending, and etc., that would affect subsequent output operation in the banknote box 500.

Referring to FIG. 20 to FIG. 25 and FIG. 1 to FIG. 3, since, in the actual use scenario, the banknote conveying module requires regular check and maintenance while the conditions, such as age, folding, damage, and etc., of the banknotes are different, the banknotes could easily be jammed between the upper banknote conveying belt C540 and the lower banknote conveying belt or in the gap between the banknote feeding cambered surface C741 and the banknote feeding guide plate C730. In such cases, the banknote conveying gap C101 has to be opened for cleaning the jammed banknotes or maintaining the banknote conveying module. Accordingly, a lid lock unit is designed in the preferred embodiment of the present invention. The lid lock unit comprises a lid C110 which has a lid slot C111 provided therein. A lid opening plate B110 is mounted in the lid slot C111. The lid opening plate B110 is affixed on an opening trough plate B230. The opening trough plate B230 is assembled and affixed with a first lid lock shaft B411 and a second lid lock shaft B412. The first lid lock shaft B411 abuts against a side of a sliding lock plate B241, while the other side of the sliding lock plate B241 abuts against the second lid lock shaft B412.

The sliding lock plate B241 is arranged on an unlock sliding plate B240. The unlock sliding plate B240 has an unlock pulley B330 arranged on a distal side thereof away from the sliding lock plate B241. The unlock pulley B330 is coupled in a rotatable manner in an unlock sliding groove B261. The unlock sliding groove B261 is formed in an unlock retaining plate B260. The unlock retaining plate B260 is mounted on an unlock mounting plate B620. An unlocking channel frame B210 and an unlock guiding plate B220 are arranged on the unlock retaining plate B260. The unlock guiding plate B220 has an unlock guiding groove B221 provided thereon. Both ends of the first lid lock shaft B411 and the second lid lock shaft B412 are slidably assembled and engaged in the unlock guiding groove B221. The first lid lock shaft B411 is affixed with one end of the lid lock extension spring B310 while the other end of the lid lock extension spring B310 is inserted into the unlocking channel frame B210 to be hooked with an unlock extension spring hole B211 formed in the unlocking channel frame B210 to connect therewith. The lid lock extension spring B310 is utilized to provide a pulling force to pull the first lid lock shaft B411 toward the unlocking channel frame B210.

A locking plate B250 is arranged on a bottom portion of the unlock retaining plate B260. A locking shaft B251 is mounted on the locking plate B250. The locking shaft B251 and a locking groove B521 are engaged and assembled so as to allow the unlock retaining plate B260 to lock the lid C110.

The locking groove B521 is provided in one end of the locking plate B520. The locking plate B520 is mounted and affixed on a locking plate rotation shaft B420. An unlock side plate B530 is affixed on the locking plate rotation shaft B420. The unlock side plate B530 is affixed on an unlock linking plate B270. The unlock linking plate B270 has two lock shaft slots B271 which are respectively engaged and assembled with the first lid lock shaft B411 and the second lid lock shaft B412, so as for driving the unlock linking plate B270 to move synchronously as the first lid lock shaft B411 and the second lid lock shaft B412 move toward the locking plate B520.

Two ends of the locking plate rotation shaft B420 are articulated with a locking mounting plate B510 which is affixed on a locking retaining plate B610. The locking retaining plate B610 is affixed on the inner wall of the housing 110. A lock shaft torsion spring B320 is sleeved on the locking plate rotation shaft B420 and adapted to provide a torsional force to rotate the locking plate B520 toward the lower banknote conveying side plate C183.

The lid C110 utilizes a reinforcing channel frame B280 and an unlocking channel frame B210 to be assembled and affixed with the unlock mounting plate B620. The reinforcing channel frame B280 is assembled and articulated with a lid hinge joint plate C120 through a first lid rotation shaft C210. Besides, a lid torsion spring C310 is sleeved on the first lid rotation shaft C210 and adapted to provide a torsional force to rotate the lid C110 toward the locking plate B250.

Preferably, the upper banknote conveying plate C181 is also assembled and affixed with an upper rotation shaft plate C193. The upper rotation shaft plate C193 is articulated with a lower rotation shaft plate C192 by means of the upper rotation shaft C220. The lower rotation shaft plate C192 is affixed on the lower banknote conveying plate C183.

When the banknote conveying gap has to be opened, the lid opening plate B110 is pulled by fingers of the hand extended in thd lid slot C111 to overcome the resilient tension of the lid lock extension spring B310 toward a direction away from the unlocking channel frame B210, such that the unlock linking plate B270 drives the locking plate B520 and the locking plate rotation shaft B520 to turn toward a direction away from the upper banknote conveying side plate C184, so as to seperate the locking groove B521 from the locking shaft B251. Then, the lid C110, the unlock mounting plate B620, and the parts mounted thereon can be opened and unfolded through rotating around the first lid rotation shaft C210 as a center. Then the upper banknote conveying plate C181 can be rotated to be opened around the upper rotation shaft C220 as a center, so as to open the banknote conveying gap C101 for checking, repairing and maintenance.

Conventional arts and technologies to person skilled in the art have not described in details in the present invention.

The above detailed description describes preferred embodiments of the present invention. It should be understood that many modifications and variations can be made by one of ordinary skill in the art without creative efforts in accordance with the concepts of the present invention. Therefore, all technical solutions that can be obtained through logic analysis, reasoning or limited experiment, on the basis of the technology with the concept of the present invention through person skilled in the art shall be within the protected scope of the present invention as defined by the appended claims.

1. A banknote conveying module, comprising:
a lower banknote conveying plate and an upper banknote conveying plate, wherein a banknote conveying gap is formed between said upper banknote conveying plate and said lower banknote conveying plate;
an upper banknote conveying belt arranged adjacent to a side of said upper banknote conveying plate in said banknote conveying gap;
a lower banknote conveying belt arranged adjacent to a side of said lower banknote conveying plate in said banknote conveying gap, wherein said lower banknote conveying belt and said upper banknote conveying belt are configured for tightly pressing against banknotes for delivering the banknotes; and
at least one banknote box provided corresponding to a set of said lower banknote conveying belt, said upper banknote conveying belt and a reversing assembly, wherein said reversing assembly comprises a reversing mounting plate affixed on a bottom portion of said lower banknote conveying plate, a plurality of reversing blocks being mounted and affixed above said reversing mounting plate, each of said reversing blocks being rotatably assembled with two lower banknote conveying side plates by a reversing shaft, one end of said reversing shaft penetrating out of one of said lower banknote conveying side plates to be tangentially connected to a telescopic shaft of a reversing electromagnet a banknote feeding cambered surface, a banknote passing planar surface and a stopping end being provided on each of said reversing blocks, said lower banknote conveying plate comprising a banknote feeding guide plate mounted at a corresponding position thereof, said stopping end being arranged at a distal end of said banknote feeding cambered surface that is away from said banknote feeding cambered surface.

2. The banknote conveying module, as recited in claim 1, wherein in an initial state, said banknote passing planar surface does not enter said banknote conveying gap and said banknote feeding cambered surface is fitted with said banknote feeding guide plate.

3. The banknote conveying module, as recited in claim 1, wherein two banknote guiding plates are respectively installed at ends of said upper banknote conveying plate and said lower banknote conveying plate where the banknotes are delivering thereto and at least one banknote receiving plate is arranged at another ends of said upper banknote conveying plate and said banknote conveying plate.

4. The banknote conveying module, as recited in claim 1, wherein said upper banknote conveying belt is wound around an upper first banknote conveying belt pulley, an upper second banknote conveying belt pulley, an upper third banknote conveying belt pulley, and an upper fourth banknote conveying belt pulley to form a first belt transmission mechanism, wherein said upper first banknote conveying belt pulley, said upper second banknote conveying belt pulley, said upper third banknote conveying belt pulley, and said upper fourth banknote conveying belt pulley are respectively mounted on an upper first banknote conveying shaft, an upper second banknote conveying shaft, an upper third banknote conveying shaft, and an upper fourth banknote conveying shaft, wherein said upper first banknote conveying shaft, said upper second banknote conveying shaft, said upper third banknote conveying shaft, and said upper fourth banknote conveying shaft are respectively assembled rotatably on upper banknote conveying side plates respectively affixed on two sides of said upper banknote conveying plate.

5. The banknote conveying module, as recited in claim 4, wherein a belt pinch roller is provided on said upper banknote conveying plate and arranged to press and hold said upper banknote conveying belt.

6. The banknote conveying module, as recited in claim 4, wherein said two upper banknote conveying side plates are respectively installed to inner sides of said two lower banknote conveying side plate, and said two lower banknote conveying side plates is rotatably assembled with a lower first banknote conveying shaft at a position corresponding to said upper first banknote conveying shaft, wherein one end of said lower first banknote conveying shaft penetrates through one of said lower banknote conveying side plate to be assembled and affixed with an encoder disk, a second-first belt pulley, and a first-second belt pulley, wherein said first-second belt pulley is connected with a first-first belt pulley through a first belt to form a second belt transmission mechanism, wherein said first-first belt pulley is mounted on an output shaft of a banknote conveying motor, wherein said banknote conveying motor is affixed inside a housing, wherein said second-first belt pulley is connected with a second-second belt pulley through a second belt to form a third belt transmission mechanism, wherein said second-second belt pulley is mounted on said lower third banknote conveying shaft, wherein a third-first belt pulley is mounted on said lower third banknote conveying shaft , wherein said third-first belt pulley is connected with a third-second belt pulley through a third belt to form a fourth belt transmission mechanism, wherein said third-second belt pulley is mounted on a lower fifth banknote conveying shaft, wherein said lower fifth banknote conveying shaft is rotatably assembled on first shaft holes arranged on said two lower banknote conveying side plates respectively and a connection belt pulley is mounted on said lower fifth banknote conveying shaft.

7. The banknote conveying module, as recited in claim 6, wherein a first lower first banknote conveying belt pulley is mounted on said lower first banknote conveying shaft at a position corresponding to said upper first banknote conveying belt pulley, wherein said lower first banknote conveying belt pulley is connected with a first lower second banknote conveying belt pulley through said lower banknote conveying belt to form a fifth belt transmission mechanism, wherein a second lower second banknote conveying belt pulley which is mounted on said lower third banknote conveying shaft is connected with a second lower first banknote conveying belt pulley through another lower banknote conveying belt to form a sixth belt transmission mechanism, wherein said second lower first banknote conveying belt pulley is mounted on a lower fourth banknote conveying shaft, wherein said lower fourth banknote conveying shaft is rotatably assembled on said two lower banknote conveying side plates.

8. The banknote conveying module, as recited in claim 7, wherein a lower connecting spacing board is mounted between said two lower banknote conveying side plates and at a position said lower banknote conveying plate and said pinch guiding wheel assembled with each other, wherein said lower connecting spacing board is arranged to connect two said lower banknote conveying side plates, wherein said pinch guiding wheel penetrates through said lower connecting spacing board to tightly press against a top portion of said banknote box for assembling.

9-10. (canceled)

11. A banknote adding machine, comprising a banknote conveying module which comprises:
a lower banknote conveying plate and an upper banknote conveying plate, wherein a banknote conveying gap is formed between said upper banknote conveying plate and said lower banknote conveying plate;
an upper banknote conveying belt arranged adjacent to a side of said upper banknote conveying plate in said banknote conveying gap;
a lower banknote conveying belt arranged adjacent to a side of said lower banknote conveying plate in said banknote conveying gap, wherein said lower banknote conveying belt and said upper banknote conveying belt are configured for tightly pressing against banknotes for delivering the banknotes; and
at least one banknote box provided corresponding to a set of said lower banknote conveying belt, said upper banknote conveying belt and a reversing assembly, wherein said reversing assembly comprises a reversing mounting plate affixed on a bottom portion of said lower banknote conveying plate, a plurality of reversing blocks being mounted and affixed above said reversing mounting plate, each of said reversing blocks being rotatably assembled with two lower banknote conveying side plates by a reversing shaft, one end of said reversing shaft penetrating out of one of said lower banknote conveying side plates to be tangentially connected to a telescopic shaft of a reversing electromagnet a banknote feeding cambered surface, a banknote passing planar surface and a stopping end being provided on each of said reversing blocks, said lower banknote conveying plate comprising a banknote feeding guide plate mounted at a corresponding position thereof, said stopping end being arranged at a distal end of said banknote feeding cambered surface that is away from said banknote feeding cambered surface.

12. The banknote adding machine, as recited in claim 11, wherein in an initial state, said banknote passing planar surface does not enter said banknote conveying gap and said banknote feeding cambered surface is fitted with said banknote feeding guide plate.

13. The banknote adding machine, as recited in claim 11, wherein two banknote guiding plates are respectively installed at ends of said upper banknote conveying plate and said lower banknote conveying plate where the banknotes are delivering thereto and at least one banknote receiving plate is arranged at another ends of said upper banknote conveying plate and said banknote conveying plate.

14. The banknote adding machine, as recited in claim 11, wherein said upper banknote conveying belt is wound around an upper first banknote conveying belt pulley, an upper second banknote conveying belt pulley, an upper third banknote conveying belt pulley, and an upper fourth banknote conveying belt pulley to form a first belt transmission mechanism, wherein said upper first banknote conveying belt pulley, said upper second banknote conveying belt pulley, said upper third banknote conveying belt pulley, and said upper fourth banknote conveying belt pulley are respectively mounted on an upper first banknote conveying shaft, an upper second banknote conveying shaft, an upper third banknote conveying shaft, and an upper fourth banknote conveying shaft, wherein said upper first banknote conveying shaft, said upper second banknote conveying shaft, said upper third banknote conveying shaft, and said upper fourth banknote conveying shaft are respectively assembled rotatably on upper banknote conveying side plates respectively affixed on two sides of said upper banknote conveying plate.

15. The banknote adding machine, as recited in claim 14, wherein a belt pinch roller is provided on said upper banknote conveying plate and arranged to press and hold said upper banknote conveying belt.

16. The banknote adding machine, as recited in claim 14, wherein said two upper banknote conveying side plates are respectively installed to inner sides of said two lower banknote conveying side plate, and said two lower banknote conveying side plates is rotatably assembled with a lower first banknote conveying shaft at a position corresponding to said upper first banknote conveying shaft, wherein one end of said lower first banknote conveying shaft penetrates through one of said lower banknote conveying side plate to be assembled and affixed with an encoder disk, a second-first belt pulley, and a first-second belt pulley, wherein said first-second belt pulley is connected with a first-first belt pulley through a first belt to form a second belt transmission mechanism, wherein said first-first belt pulley is mounted on an output shaft of a banknote conveying motor, wherein said banknote conveying motor is affixed inside a housing, wherein said second-first belt pulley is connected with a second-second belt pulley through a second belt to form a third belt transmission mechanism, wherein said second-second belt pulley is mounted on said lower third banknote conveying shaft, wherein a third-first belt pulley is mounted on said lower third banknote conveying shaft, wherein said third-first belt pulley is connected with a third-second belt pulley through a third belt to form a fourth belt transmission mechanism, wherein said third-second belt pulley is mounted on a lower fifth banknote conveying shaft, wherein said lower fifth banknote conveying shaft is rotatably assembled on first shaft holes arranged on said two lower banknote conveying side plates respectively and a connection belt pulley is mounted on said lower fifth banknote conveying shaft.

17. The banknote adding machine, as recited in claim 16, wherein a first lower first banknote conveying belt pulley is mounted on said lower first banknote conveying shaft at a position corresponding to said upper first banknote conveying belt pulley, wherein said lower first banknote conveying belt pulley is connected with a first lower second banknote conveying belt pulley through said lower banknote conveying belt to form a fifth belt transmission mechanism, wherein a second lower second banknote conveying belt pulley which is mounted on said lower third banknote conveying shaft is connected with a second lower first banknote conveying belt pulley through another lower banknote conveying belt to form a sixth belt transmission mechanism, wherein said second lower first banknote conveying belt pulley is mounted on a lower fourth banknote conveying shaft, wherein said lower fourth banknote conveying shaft is rotatably assembled on said two lower banknote conveying side plates.

18. The banknote adding machine, as recited in claim 17, wherein a lower connecting spacing board is mounted between said two lower banknote conveying side plates and at a position said lower banknote conveying plate and said pinch guiding wheel assembled with each other, wherein said lower connecting spacing board is arranged to connect two said lower banknote conveying side plates, wherein said pinch guiding wheel penetrates through said lower connecting spacing board to tightly press against a top portion of said banknote box for assembling.

19. The banknote adding machine, as recited in claim 11, further comprising a housing having an opening formed on a side thereof and an integrated box mounted therein, a bottom of said housing being a bottom wall, said integrated box being slidably assembled with an inner wall of said housing through a sliding rail, said opening of said housing being opened and closed through a box door mechanism thereat, a banknote box being mounted in said integrated box, a positioning driving mechanism being mounted on a bottom of the banknote box;
said banknote box comprising a banknote receiving wheel mounted on a banknote receiving shaft, said banknote receiving shaft being rotatably assembled on an inner wall of said banknote box, said banknote receiving wheel and said driving wheel being engaged for transmission, said banknote receiving wheel being positioned under a gap formed between said banknote feeding cambered surface and said banknote feeding guide plate, a driving wheel being mounted on a driving shaft, a second belt pulley being mounted on said driving shaft, said driving shaft being rotatably mounted on a support board, said support board being affixed on an outer wall of said banknote box, said second belt pulley being connected with a first belt pulley through a driving belt to form a belt transmission mechanism, said first belt pulley being affixed on said output shaft of a banknote receiving motor, said banknote receiving motor being affixed on the support board;
said box door mechanism comprising a box door, said box door having a box door through groove a box door opening plate being installed in said box door through groove, said box door opening plate being assembled and affixed with a box door hinge, said box door having a box door hinge retaining plate and a box door channel frame at an inner side of said housing, said box door hinge retaining plate sealing a part of said box door through groove adjacent to an inside of said housing, a box door lock shaft being rotatably assembled on said box door hinge retaining plate;
two ends of said box door lock shaft being assembled and affixed on a box door lock plate, said box door lock plate having a box door lock groove and a box door spring hole arranged thereon, said box door lock groove and a box door lock pin being engaged with each other, an end of said box door lock pin being affixed on said inner wall of said housing, said box door spring hole and an end of a box door extension spring being hookedly assembled, another end of said box door extension spring and a box door extension spring hole being hookedly assembled, said box door extension spring hole being arranged on a box door spring plate, said box door spring plate being affixed on said housing;
a top of said housing being closed through said lower banknote conveying plate, each of three side walls of said housing adjacent to said integrated box and a top of said lower banknote conveying plate having a pinch guiding wheel rotatably mounted thereon, said pinch guiding wheels on said three side walls of said housing respectively tightly pressing against three sides of said integrated box, while said pinch guiding wheel on said lower banknote conveying plate tightly pressing a top of said banknote box.

20. The banknote adding machine, as recited in claim 18, further comprising a housing having an opening formed on a side thereof and an integrated box mounted therein, a bottom of said housing being a bottom wall, said integrated box being slidably assembled with an inner wall of said housing through a sliding rail, said opening of said housing being opened and closed through a box door mechanism thereat, a banknote box being mounted in said integrated box, a positioning driving mechanism being mounted on a bottom of the banknote box;
said banknote box comprising a banknote receiving wheel mounted on a banknote receiving shaft, said banknote receiving shaft being rotatably assembled on an inner wall of said banknote box, said banknote receiving wheel and said driving wheel being engaged for transmission, said banknote receiving wheel being positioned under a gap formed between said banknote feeding cambered surface and said banknote feeding guide plate, a driving wheel being mounted on a driving shaft, a second belt pulley being mounted on said driving shaft, said driving shaft being rotatably mounted on a support board, said support board being affixed on an outer wall of said banknote box, said second belt pulley being connected with a first belt pulley through a driving belt to form a belt transmission mechanism, said first belt pulley being affixed on said output shaft of a banknote receiving motor, said banknote receiving motor being affixed on the support board;
said box door mechanism comprising a box door, said box door having a box door through groove a box door opening plate being installed in said box door through groove, said box door opening plate being assembled and affixed with a box door hinge, said box door having a box door hinge retaining plate and a box door channel frame at an inner side of said housing, said box door hinge retaining plate sealing a part of said box door through groove adjacent to an inside of said housing, a box door lock shaft being rotatably assembled on said box door hinge retaining plate;
two ends of said box door lock shaft being assembled and affixed on a box door lock plate, said box door lock plate having a box door lock groove and a box door spring hole arranged thereon, said box door lock groove and a box door lock pin being engaged with each other, an end of said box door lock pin being affixed on said inner wall of said housing, said box door spring hole and an end of a box door extension spring being hookedly assembled, another end of said box door extension spring and a box door extension spring hole being hookedly assembled, said box door extension spring hole being arranged on a box door spring plate, said box door spring plate being affixed on said housing;
a top of said housing being closed through said lower banknote conveying plate, each of three side walls of said housing adjacent to said integrated box and a top of said lower banknote conveying plate having a pinch guiding wheel rotatably mounted thereon, said pinch guiding wheels on said three side walls of said housing respectively tightly pressing against three sides of said integrated box, while said pinch guiding wheel on said lower banknote conveying plate tightly pressing a top of said banknote box.
